(19) United States
(12) Patent Application Publication
(10) Pub. No.: US 2007/0238042 A1
(43) Pub. Date: Oct. 11, 2007

(54) OILLESS-FIXING TONER, AND IMAGE FORMING METHOD, APPARATUS AND PROCESS CARTRIDGE USING THE OILLESS-FIXING TONER

(76) Inventors: Hideaki Yasunaga, Ibaraki-shi (JP); Hiroaki Katoh, Nagaokakyo-shi (JP); Masayuki Hagi, Minoo-shi (JP); Takuya Kadota, Kobe-shi (JP); Yoshimichi Ishikawa, Itami-shi (JP); Hiroyuki Murakami, Toyonaka-shi (JP); Katsunori Kurose, Takarazuka-shi (JP); Yoshihiro Mikuriya, Nishinomiya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/696,879

(22) Filed: Apr. 5, 2007

(30) Foreign Application Priority Data
Apr. 5, 2006 (JP) 2006-104438

(51) Int. Cl. G03G 9/08

(52) U.S. Cl. 430/108.1; 430/123.51; 430/111.4

(57) ABSTRACT

An oilless-fixing toner is provided for use in a vertical image developer including a toner feeder feeding the oilless-fixing toner vertically below; a developing roller located vertically below the toner feeder; and a screw blade agitating the oilless-fixing toner, wherein the oilless-fixing toner contains:
a resin including a wax;
a colorant; and
an external additive,
   wherein a total energy determined from a torque and a load of the screw blade is from 450 to 530 mJ when rotating in the oilless-fixing toner at 100 mm/s, and a ratio of total energy at 10 mm/s to total energy at 100 mm/s is from 2.0 to 3.0.

### BACKGROUND OF THE INVENTION

1. Field of the Invention

The present invention relates to an oilless-fixing toner, and to an image forming method, apparatus and process cartridge using the oilless-fixing toner.

2. Discussion of the Background

Recently, electrophotographic image forming methods are becoming more widely used, particularly one-component developing methods using a one-component developer including only a toner.

Published Unexamined Japanese Patent Application No. 2003-330273 discloses a toner having a specific fluidity, which produces high-quality images without variation of image density when forming an image with an image forming apparatus such as a laser printer, wherein the fluidity of the toner is evaluated by a powder tester measuring that of a residue thereof remaining after being sieved. However, the fluidity data fluctuate widely and differ among measurers.

Published Unexamined Japanese Patent Application No. 2004-37651 discloses a precise method of evaluating the fluidity of a toner without individual difference among measurers, wherein the fluidity is evaluated by measuring torques and loads of the rotating blade when entering a powder layer and drawing therefrom. However, since the speed dependency and absolute energy value of the rotating blade are not specified, the oilless-fixing toner behavior cannot be stabilized.

Published Unexamined Japanese Patent Application No. 2004-37971 discloses a method of precisely and simply evaluating the fluidity of a toner, wherein the fluidity is evaluated by measuring a torque and a load of a conical rotor when entering the toner. However, since the speed dependency and absolute energy value of the rotating blade are not specified, the oilless-fixing toner behavior cannot be stabilized.

Published Unexamined Japanese Patent Application No. 2004-117211 discloses an apparatus precisely evaluating the fluidity of a toner without individual difference among measurers, and a toner evaluated thereby, which has good transportability and reproducibility, and stably produces high-quality images, wherein the fluidity is evaluated by measuring a torque and a load of a conical rotor when entering the toner which is preliminarily pressurized. Nevertheless, since the speed dependency and absolute energy value of the rotating blade are not specified, the oilless-fixing toner behavior cannot be stabilized.

The oilless-fixing toner is vulnerable to heat and stress when pulverized because a wax tends to be present in the pulverized interface. Therefore, an external additive is firmly fixed on the toner in a specific amount. However, when the toner is used in a vertical image developer contacting its toner feed roller with its developing roller, the toner is so consolidated that the toner cannot be supplied well because a large torque is applied to the toner feed roller.

Because of these reasons, a need exists for an oilless-fixing toner having good fluidity, which is free from being poorly charged and which stably produces quality images without uneven image density.

### SUMMARY OF THE INVENTION

Accordingly, an object of the present invention is to provide an oilless-fixing toner having good fluidity, which is free from being poorly charged and which stably produces quality images without uneven image density.

Another object of the present invention is to provide an image forming method using the oilless-fixing toner.

A further object of the present invention is to provide an image forming apparatus using the oilless-fixing toner.

Another object of the present invention is to provide a process cartridge using the oilless-fixing toner.

These objects and other objects of the present invention, either individually or collectively, have been satisfied by the discovery of an oilless-fixing toner for use in a vertical image developer comprising a toner feeder feeding the oilless-fixing toner vertically below; a developing roller located vertically below the toner feeder; and a screw blade agitating the oilless-fixing toner, which comprises:

a resin comprising a wax;

a colorant; and

an external additive,

wherein a total energy determined from a torque and a load of the screw blade is from 450 to 530 mJ when rotating in the oilless-fixing toner at 100 mm/s, and a ratio of the total energy at 10 mm/s to that at 100 mm/s is from 2.0 to 3.0.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a cross-sectional view illustrating a substantial part of the image forming apparatus including the image developer and process cartridge of an embodiment of the present invention; and

FIG. 2 is a cross-sectional view illustrating an image developer and process cartridge of an embodiment of the present invention.

### DETAILED DESCRIPTION OF THE INVENTION

The present invention provides an oilless-fixing toner having good fluidity, which is free from being poorly charged and which stably produces quality images without uneven image density.

The toner of the present invention is an oilless-fixing toner for use in a vertical image developer comprising a toner feeder (feed roller) feeding the oilless-fixing toner vertically below; a developing roller located vertically below the toner feeder; and a screw blade agitating the oilless-fixing toner, which comprises a resin comprising a wax; a colorant; and an external additive, wherein a total energy determined from a torque and a load of the screw blade is from 450 to 530 mJ when rotating in the oilless-fixing toner at 100 mm/s, and a ratio of the total energy at 10 mm/s to that at 100 mm/s is from 2.0 to 3.0.

When the total energy at 100 mm/s is greater than 530 mJ, the feed roller is not stably driven or is not rotated to feed the toner because a large torque is required to drive the feed roller. 450 mJ is substantially the minimum for a pulverized oilless-fixing toner because the toner needs to be spherical to make the total energy less than 450 mJ. The rotating speed changes because the linear speed changes due to receiving papers. The torque is preferably changeless and stable even when the linear speed changes.

When the ratio of total energy at 10 mm/s to total energy at 100 mm/s is greater than 3.0, the interparticle friction changes significantly due to the rotating speed and the feed roller is not rotated to feed the toner due to a torque-up when the linear speed lowers because of a thick paper, etc. In order to stably feed and transport thick papers and thin papers, it is necessary to control the paper feed and transport speed. Then, the speed of the whole system changes and the torque preferably depends less on the speed. 2.0 as the ratio of the total energy at 10 mm/s to that at 100 mm/s is substantially the minimum for a pulverized oilless-fixing toner.

When the load energy at 100 mm/s is greater than 30 mJ, the interparticle friction is so large that a force applied to the toner directly leads to a torque-up when transporting the toner, and therefore the feed roller is not rotated to feed the toner. A load energy not greater than 20 mJ at 100 mm/s is substantially the minimum for a pulverized oilless-fixing toner.

Further, when the load energy at 10 mm/s is greater than 75 mJ, the interparticle friction is so large that a force applied to the toner directly leads to a torque-up when transporting the toner, and therefore the feed roller is not rotated to feed the toner. The load energy not greater than 65 mJ at 10 mm/s is substantially the minimum for a pulverized oilless-fixing toner.

The total energy when a force of 5N is initially applied to the toner is preferably from 800 mJ to 1,000 mJ. When greater than 1,000 mJ, an initial torque-up occurs at the contact point between the developing roller and feed roller, and therefore the feed roller is not rotated to feed the toner. 800 mJ is substantially the minimum for a pulverized oilless-fixing toner. The toner is a toner present at a regulator of the image developer for a long time.

When the total energy is greater than 550 mJ when a force of 5N is applied to the toner for the second time in a row, an excess torque-up occurs at the contact point between the developing roller and feed roller, and therefore the feed roller is not rotated to feed the toner. This is an indication of the driving stability of the feed roller, i.e., the looseness of the toner, and the total energy is preferably not greater than 550 mJ.

The toner of the present invention preferably has a volume-average particle diameter of from 5 to 12 μm, and more preferably from 8 to 10 μm.

In addition, the resin in the toner includes a wax to maintain and improve separativeness between a paper and a fixer when a toner image on the paper is fixed thereon.

The toner of the present invention may include a first binder resin including a hydrocarbon wax, a second binder resin, a colorant, a charge controlling agent and an external additive.

The binder resins are not limited, and may be known resins such as polyester resins, (meth)acrylic resins, styrene-(meth)acrylic copolymer resins, epoxy resins and cyclic olefin resins, e.g., TOPAS-COC from Ticona. Nevertheless, polyester resins are preferably used in terms of oilless-fixing.

The polyester resin is typically formed by polycondensation between a polyol and a polycarboxylic acid. Specific examples of diols in the polyols include, but are not limited to, adducts of a bisphenol A such as polyoxypropylene(2,2)-2,2-bis(4-hydroxyphenyl)propane, polyoxypropylene(3,3)-2,2-bis(4-hydroxyphenyl)propane, polyoxypropylene(6)-2,2-bis(4-hydroxyphenyl)propane, polyoxyethylene(2,0)-2,2-bis(4-hydroxyphenyl)propane; ethylene glycol; diethylene glycol; triethylene glycol; 1,2-propylene glycol; 1,3-propylene glycol; 1,4-butadieneol; neo-pentyl glycol; 1,4-butenediol; 1,5-pentanediol; 1,6-hexanediol; 1,4-cyclohexanedimethanol; dipropyleneglycol; polyethyleneglycol; polytetramethyleneglycol; bisphenol A; hydrogenated bisphenol A; etc. Specific examples of tri- or more valent alcohols include, butarenotlimitedto, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, 1,3,5-trihydroxybenzene, etc.

Specific examples of dicarboxylic acids in the polycarboxylic acids include, but are not limited to, maleic acid, fumaric acid, citraconic acids, itaconic acid, glutaconic acid, phthalic acid, isophthalic acid, terephthalic acid, cyclohexane dicarboxylic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, isooctenylsuccinic acid, n-octylsuccinic acid, isooctylsuccinic acid, their anhydrides or lower alkyl esters, etc. Specific examples of tricarboxylic acids include, but are not limited to, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-methylenecarboxypropane, tetra(methylenecarboxyl)methane, 1,2,7,8-octantetracarboxylic acid, an empol trimer acid, and their anhydrides and lower alkyl esters, etc.

In the present invention, a vinyl polyester resin is preferably used, which is prepared by a combination of a polycondensation reaction forming a polyester resin and a radical polymerization reaction forming a vinyl resin in a same container, using a mixture of a polyester resin material monomer, a vinyl resin material monomer and a monomer reacting with both material monomers. The monomer reacting with both material monomers is, i.e., a monomer usable in both of the polycondensation reaction and radical polymerization reaction. Namely, the monomer is a monomer having a polycondensation-reactable carboxyl group and a radical-polymerization-reactable vinyl group such as fumaric acid, maleic acid, acrylic acid and methacrylic acid.

The polyester resin material monomer includes the above-mentioned polyols and polycarboxylic acids. The vinyl material monomer includes, but is not limited to, styrenes or their derivatives such as styrene, o-methylstyrene, m-methylstyrene, p-methylstyrene, α-methylstyrene, p-ethylstyrene, 2,4-dimethylstyrene, p-tert-butylstyrene and p-chlorostyrene; ethylene unsaturated monoolefins such as ethylene, propylene, butylene and isobutylene; methacrylate alkyl esters such as methylmethacrylate, n-propylmethacrylate, isopropylmethacrylate, n-butylmethacrylate, isobutylmethacrylate, t-butylmethacrylate, n-pentylmethacrylate, isopentylmethacrylate, neopentylmethacrylate, 3-(methyl)butylmethacrylate, hexylmethacrylate, octylmethacrylate, nonylmethacrylate, decylmethacrylate, undecylmethacrylate and dodecylmethacrylate; acrylate alkyl esters such as methylacrylate, n-propylacrylate, isopropylacrylate, n-butylacrylate, isobutylacrylate, t-butylacrylate, n-pentylacrylate, isopentylacrylate, neopentylacrylate, 3-(methyl)butylacrylate, hexylacrylate, octylacrylate, nonylacrylate, decylacrylate, undecylacrylate and dodecylacrylate; unsaturated carboxylic acids such as acrylic acid, methacrylic acid, itaconic acid and maleic acid; acrylonitrile; maleate esters; itaconate esters; vinylchloride; vinylacetate; vinylbenzoate; vinylmethylethylketone; vinylhexylketone; vinylmethylether; vinylethylether; vinylisobutylether; etc. Specific examples of a polymerization initiator for polymerizing the vinyl resin material monomer include, but are not limited to, azo or diazo polymerization initiators such as 2,2′-azobis(2,4-dimethylvaleronitrile), 2,2′-isobutyronitrile, 1,1′-azobis(cyclohexane-1-carbonitrile) and 2,2′-azobis-4-methoxy-2,4-dimethylvaleronitrile; and peroxide polymerization initiators such as benzoylperoxide, dicumylperoxide, methylethylketoneperoxide, isopropylperoxycarbonate and lauroylperoxide.

The above-mentioned polyester resins are preferably used as a binder resin, and the following first and second binder resins are more preferably used in terms of improving the separativeness and offset resistance of the resultant oilless-fixing toner.

The first binder resin is a polyester resin prepared by polycondensing an adduct of bisphenol A with alkyleneoxide as the polyol, and terephthalic acid and fumaric acid as the polycarboxylic acid.

The second binder resin is a vinyl polyester resin prepared by using an adduct of bisphenol A with alkyleneoxide, terephthalic acid, trimellitic acid and succinic acid as the polyester resin material monomer; styrene and butylacrylate as the vinyl resin material monomer; and fumaric acid as the monomer reactive with both of the material monomers.

The first binder resin includes a hydrocarbon wax as mentioned above. In order to include a hydrocarbon wax in the first binder resin, the hydrocarbon wax is included in monomers forming the first binder resin when synthesized. For example, the hydrocarbon wax is included in an acid monomer and an alcohol monomer forming a polyester resin as the first binder resin, and the acid monomer and alcohol monomer are polycondensed. When the first binder resin is a vinyl polyester resin, the hydrocarbon wax is included in a polyester resin material monomer and a vinyl resin material monomer is dropped therein while stirred and heated to perform a polycondensation reaction and a radical polymerization reaction.

Typically, the lower the polarity of a wax, the better the releasability thereof from a fixing member (roller). The wax for use in the present invention is preferably a hydrocarbon wax having a low polarity.

The hydrocarbon wax is a wax formed of only carbon atoms and hydrogen atoms, and does not include an ester group, an alcohol group or an amide group. Specific examples of the hydrocarbon wax include, but are not limited to, polyolefin waxes such as polyethylene, polypropylene and a copolymer between ethylene and propylene; petroleum waxes such as a paraffin wax and a microcrystalline wax; and synthetic waxes such as a Fischer-Tropsch wax. In the present invention, the polyethylene wax, the paraffin wax and the Fischer-Tropsch wax are preferably used, and the polyethylene wax and the paraffin wax are more preferably used.

The toner of the present invention may include a wax dispersant improving dispersion of the wax. The wax dispersants are not particularly limited, and known wax dispersants can be used. Specific examples thereof include, but are not limited to, polymers and oligomers including a block formed of a unit having high compatibility with a wax and a unit having high compatibility with a resin; polymers and oligomers wherein either of a unit having high compatibility with a wax and a unit having high compatibility with a resin is grafted with the other; copolymers of unsaturated hydrocarbons such as ethylene, propylene, butene, styrene and α-styrene and α,β-unsaturated carboxylic acids, such as acrylic acid, methacrylic acid, maleic acid, itaconic acid, and their esters or anhydrides; and a block or grafted body of vinyl resins and polyester.

Specific examples of the unit having high compatibility with a wax include, but are not limited to, long-chain alkyl groups having 12 or more carbon atoms, polyethylene, polypropylene, polybutene, polybutadiene and their copolymers. Specific examples of the unit having high compatibility with a resin include, but are not limited to, polyesters and vinyl resins.

In the present invention, the melting point of the wax is an endothermic peak thereof, which is measured with a differential scanning calorimeter when heated, and is preferably from 70 to 90° C. When higher than 90° C., the wax insufficiently melts in the fixing process and the resultant toner does not have sufficient separativeness. When lower than 70° C., the resultant toner has a problem of storage stability because the toner particles melt and are bonded with each other in an environment of high-temperature and humidity. The wax more preferably has a melting point of from 70 to 90° C., and furthermore preferably from 70 to 80° C. such that the resultant toner has sufficient separativeness.

The wax preferably has a half-value width of the endothermic peak not greater than 7° C., which is measured with a differential scanning calorimeter when heated. The wax in the present invention comparatively has a low melting point and a broad endothermic peak. Namely, a wax melting at a low temperature adversely affects the storage stability of the resultant toner.

The toner of the present invention preferably includes a wax in an amount of form 3 to 10% by weight, more preferably from 3 to 8% by weight, and furthermore preferably from 3.5 to 6% by weight. When less than 3% by weight, the wax does not sufficiently exude between the melted toner and the fixing member in the fixing process. Therefore, the adhesiveness therebetween does not decrease and a recording member does not separate from the fixing member. When greater than 10% by weight, the wax exposing on the surface of a toner increases, resulting in deterioration of fluidity of the resultant toner. Therefore, not only the resultant image quality noticeably deteriorates because of deterioration of transferability of the toner from the developing unit to the photoreceptor and to the recording member therefrom, but also the wax desorbs from the surface of a toner, resulting in contamination of the developing unit and the photoreceptor.

The first binder resin (including a wax) and the second binder resin in a toner preferably have a weight ratio of from 20/80 to 45/55, and more preferably from 30/70 to 40/60. When the first binder resin has too low a weight ratio, the separativeness and hot offset resistance of the resultant toner deteriorate. When the first binder resin has too high a weight ratio, the glossiness and thermostable storage stability of the resultant toner deteriorate.

The binder resin formed of the first binder resin and the second binder resin preferably has a softening point of from 110 to 135° C., and more preferably from 125 to 130° C.

The first binder resin including a wax preferably has an acid value of from 5 to 50 KOH mg/g, and more preferably from 10 to 40 KOH mg/g. The second binder resin preferably has an acid value of from 0 to 10 KOH mg/g, and more preferably from 1 to 5 KOH mg/g. Particularly, polyester resins having such acid values improve dispersibilities of colorants and form a toner having good chargeability.

The first binder resin including a wax preferably includes a tetrahydrofuran (THF)-insoluble component in an amount of from 0.1 to 15% by weight, more preferably from 0.2 to 10% by weight, and furthermore preferably from 0.3 to 5% by weight in terms of hot offset resistance.

Known charge controlling agents conventionally used in full color toners can be used. Specific examples thereof include, but are not limited to, Nigrosine dyes, triphenylmethane dyes, chromium-containing metal complex dyes, molybdic acid chelate pigments, Rhodamine dyes, alkoxyamines, quaternary ammonium salts (including fluorine-modified quaternary ammonium salts) alkylamides, phosphor and its compounds, tungsten and its compounds, fluorine-containing activators, metal salts of salicylic acid, metal salts of salicylic acid derivatives, etc. Specific examples of marketed charge controlling agents include BONTRON P-51 (quaternary ammonium salt), BONTRON E-82 (metal complex of oxynaphthoic acid), BONTRON E-84 (metal complex of salicylic acid), and BONTRON E-89 (phenolic condensation product) which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and COPY CHARGE NX VP434 (quaternary ammonium salt), which are manufactured by Hoechst AG; LRA-901, and LR-147 (boroncomplex) which are manufactured by Japan Carlit Co., Ltd.; quinacridone, azo pigments, and polymers having a functional group such as a sulfonate group, a carboxyl group, a quaternary ammonium group, etc. Particularly, a charge controlling agent controlling a toner so as to have a negative polarity is preferably used.

The content of the charge controlling agent in the toner is determined depending on the variables such as choice of binder resin, presence of additives, and dispersion method. In general, the content of the charge controlling agent is preferably from 0.1 to 10 parts by weight, and more preferably from 1 to 5 parts by weight, per 100 parts by weight of the binder resin included in the toner. When the content is too low, a good charge property cannot be imparted to the toner. When the content is too high, the charge quantity of the toner excessively increases, and thereby the electrostatic attraction between the developing roller and the toner increases, resulting in deterioration of fluidity and decrease of image density.

Known colorants conventionally used in full color toners can be used in the toner of the present invention.

Specific examples of the colorant include, but are not limited to, carbon black, Aniline Blue, calcoil blue, chrome yellow, ultramarine blue, Dupont Oil Red, QUINOLINE YELLOW, Methylene blue-chloride, Copper Phthalocyanine, Malachite Green Oxalate, lamp black, Rose Bengal, C.I. Pigment Red 48:1, C.I. Pigment Red 122, C.I. Pigment Yellow 97, C.I. Pigment Yellow 12, C.I. Pigment Yellow 17, C.I. Pigment Yellow 74, C.I. Solvent Yellow 162, C.I. Pigment Yellow 180, C.I. Pigment Yellow 185, C.I. Pigment Blue 15:1, C.I. Pigment Blue 15:3, etc. The toner preferably includes the colorant in an amount of from 2 to 15 parts by weight per 100 parts by weight of all the binder resin. The colorant is preferably dispersed in a mixed binder resin of the first and second binder resins in the form of a masterbatch. The masterbatch preferably includes the colorant in an amount of from 20 to 40 parts by weight.

In the present invention, one or more inorganic particulate materials are preferably used as external additives to support the fluidity, chargeability, developability and transferability of the resultant toner.

The inorganic particulate material preferably has a specific surface area of from 30 to 300 m²/g when measured by a BET method, and an average primary particle diameter of from 10 to 50 nm. When the average primary particle diameter is too large, the inorganic particulate material is difficult to fix on a mother toner. When less than 10 nm, the inorganic particulate material is often buried in the mother toner.

Specific examples of the inorganic particulate material include, but are not limited to, silicon oxide, zinc oxide, tin oxide, quartz sand, titanium oxide, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc. The mother toner preferably includes the inorganic particulate material in an amount of from 2.0 to 5.0 parts by weight. When the mother toner includes too much of the inorganic particulate, the developability and separativeness after fixed of the resultant toner deteriorate, producing foggy images. When too little, the fluidity, transferability and thermostable storage stability deteriorate.

Particularly, silica (silicon dioxide) is preferably used as a fluidizer supporting the fluidity of the resultant toner, and the fluidizer preferably has a bond strength to the mother toner of from 45 to 65%. When less than 45%, free fluidizers adversely affect the resultant image. When greater than 65%, the fluidizers are buried in the mother toner too much, resulting in fading of the spacer effect.

Next, the vertical image developer will be explained.

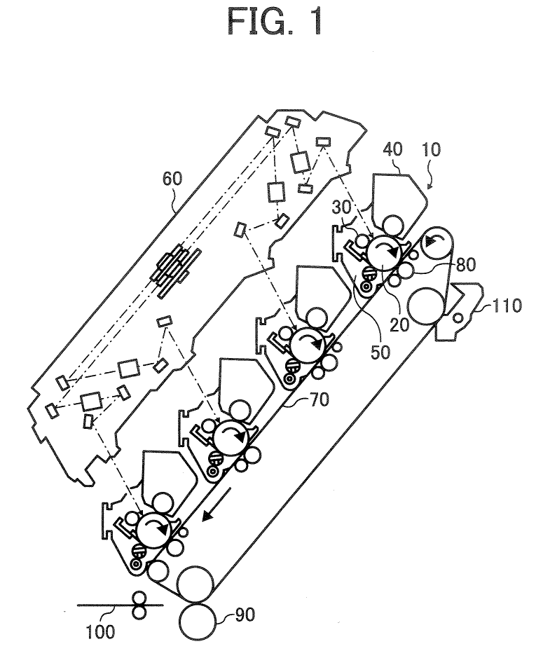

FIG. 1 is a cross-sectional view illustrating a substantial part of the image forming apparatus including the image developer and process cartridge of a preferred embodiment of the present invention.

Each of process cartridges (10) includes a photoreceptor drum (20), a charging roller (30), an image developer (40) and a cleaner (50). Each of the process cartridges (10) can be exchanged by unlocking each of the stoppers therefor.

The photoreceptor drum (20) rotates in the direction of the depicted arrow at a peripheral speed of 150 mm/sec. The charging roller (30) is contacted to the surface of the photoreceptor drum (20) upon application of pressure, and is driven to rotate by the rotation of the photoreceptor drum (20). A predetermined bias is applied to the charging roller (30) from a high-voltage power source (not shown), and the charging roller (30) charges the surface of the photoreceptor drum (20) at −500 V. An irradiator (60) irradiates the photoreceptor drum (20) with imagewise light to form a latent image thereon. A laser beam scanner using a laser diode or a LED is used for the irradiator (60). The image developer (40) using a one-component contact developing method visualizes the latent image on the photoreceptor drum (20) as a toner image. A predetermined developing bias is provided to the image developer (40) from a high-voltage power source (not shown). The cleaner (50) removes the toner remaining on the surface of the photoreceptor drum (20) after transferred.

Four process cartridges (10) are located parallel to the moving direction of an intermediate transfer belt (70) and form a visible image in order of yellow, cyan, magenta and black. A first transfer bias is applied to a first transfer roller (80), and the toner image on the photoreceptor drum (20) is transferred onto the intermediate transfer belt (70). The intermediate transfer belt (70) is driven by a drive motor (not shown) to rotate in the direction of the depicted arrow, visible images having each color are sequentially transferred and overlapped to form a full-color image thereon.

The full-color image is transferred onto a paper (100) as a transfer material when a predetermined voltage is applied to a second transfer roller (90), and is fixed by a fixer (not shown) and discharged. The toner remaining on the intermediate transfer belt (70), which is not transferred by the second transfer roller (90), is collected by a transfer belt cleaner (110).

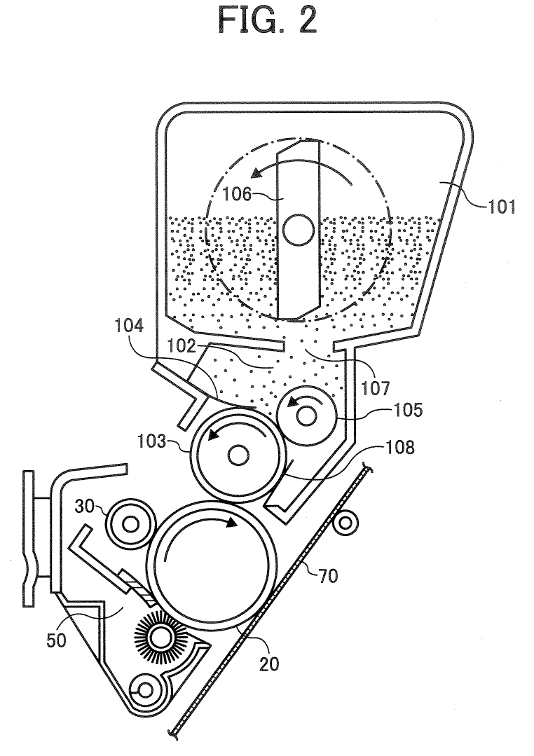

FIG. 2 is a cross-sectional view illustrating the image developer and process cartridge of a preferred embodiment of the present invention.

The image developer (40) includes a toner container (101) and a toner feed chamber (102) below the toner container (101). A developing roller (103), and a layer regulator (104) and a feed roller (105) contacting the developing roller (103) are located below the toner feed chamber (102). The developing roller (103) contacts the photoreceptor drum (20) a predetermined developing bias is applied to the developing roller (103) from a high-voltage power source (not shown). A toner agitator (106) in the toner container (101) rotates in an anticlockwise direction to fluidize a toner therein and drives the toner down into the toner feed chamber (102) through an opening (107). The opening (107) is right above the feed roller (105), and only a partition separating the toner container (101) and the toner feed chamber (102) is located right above the layer regulator (104). The surface of the feed roller (105) is coated with a foamed material including a cell, and efficiently absorbs the toner in the toner feed chamber (102) and prevents deterioration of the toner at a contact point with the developing roller (103) due to a pressure concentration. The foamed material is an electroconductive material including a particulate carbon and having an electric resistivity of from 10³ to 10¹³Ω. A feed bias offset in the same direction of the polarity of the charged toner is applied to the feed roller (105). The feed bias presses the preliminarily charged toner toward the developing roller (103) at the contact point therewith. The feed roller (105) rotates in an anticlockwise direction to coat (feed) the toner absorbed on the surface thereof onto the surface of the developing roller (103).

The developing roller (103) uses a roller coated with an elastic rubber layer, and a surface layer including a material chargeable to have a polarity reverse to that of the toner is formed on the elastic rubber layer. The elastic rubber layer has a hardness not greater than 50° (JIS-A) to uniformly contact the photoreceptor drum (20), and an electric resistivity of from 10³ to 10¹⁰Ω to activate the developing bias. The elastic rubber layer has a surface roughness of from 0.2 to 2.0 μm Ra, and holds a required amount of the toner. The developing roller (103) rotates in an anticlockwise direction to transport the toner held on the surface thereof to opposed positions to the layer regulator (104) and the photoreceptor drum (20).

The layer regulator (104) is formed of a metallic plate spring made of SUS304CSP, SUS301CSP or a phosphor bronze, etc. The free end thereof contacts the surface of the developing roller (103) at pressure of from 10 to 100 N/m to thin and frictionally charge the toner layer passed thereunder. Further, a regulation bias offset in the same direction of the polarity of the charged toner is applied to the layer regulator (104) to support that to frictionally charge the toner.

The photoreceptor drum (20) rotates in a clockwise direction, and therefore the surface of the developing roller (103) moves in the same direction of the photoreceptor drum (20) at an opposed position thereto. The thin-layered toner is transported by the rotation of the developing roller (103) to the opposed position to the photoreceptor drum (20), and is transferred onto the surface thereof according to a developing bias applied to the developing roller (103) and an electric field formed by an electrostatic latent image on the photoreceptor drum (20) to form a toner image.

A seal (108) is located contacting the developing roller (103) in a place where the toner remaining on the developing roller (103) returns into the toner feed chamber (102) again, which was not transferred on to the photoreceptor drum (20), such that the toner is not leaked out of the image developer.

Specific examples of the elastics rubber on the surface of the developing roller include, but are not limited to, styrene-butadiene copolymer rubbers, acrylonitrile-butadiene copolymer rubbers, acrylic rubbers, epichlorohydrin rubbers, urethane rubbers and silicon rubbers. These can be used alone or in combination. Particularly, combinations of the epichlorohydrin rubbers and the acrylonitrile-butadiene copolymer rubbers are preferably used.

The developing roller of the present invention is formed of an electroconductive shaft coated with an elastic rubber. The electroconductive shaft is, e.g., a metal such as stainless.

In the present invention, a two-roll fixing method using a heat roller and pressure roller is preferably used.

A fixer using an oilless fixing method without application of oil is preferably used.

The charger for use in the present invention has the shape of a cylinder, including a shaft, an electroconductive layer coated thereon and a surface layer coated on the electroconductive layer. A voltage applied to the shaft from a power source is applied to a latent image bearer through the electroconductive layer and the surface layer to charge the surface of the latent image bearer.

The shaft of the charger is located along the longitudinal direction of (parallel to the shaft of) the latent image bearer, and the charger is wholly pressed to the latent image bearer at a predetermined pressure. Thus, a part of the surface of the latent image bearer and a part of the surface of the charger contacts each other along the longitudinal directions of the both to from a contact nip having a predetermined width. The latent image bearer is driven to rotate by a driver and the charger rotates in accordance with the rotation of the image bearer.

The latent image bearer is charged through a neighborhood of the contact nip. The surface of the charger and the surface of the latent image bearer to be charged (equivalent to the length of the charger) uniformly contact each other through the contact nip, and the surface of the latent image bearer to be charged is uniformly charged.

The electroconductive layer of the charger is a nonmetal and preferably formed of a material having low hardness to stably contact the image bearer. Specific examples thereof include, but are not limited to, resins such as polyurethane, polyether and polyvinyl alcohol; and rubbers such as hydrin rubbers, EPDM and NBR. Specific examples of the electroconductive materials include, but are not limited to, carbon black, graphite, titanium oxide, zinc oxide, etc. The surface layer is formed of a material having a medium resistivity of from 10² to 10¹⁰Ω.

Specific examples of resins for use in the surface layer include, but are not limited to, nylon, polyamide, polyimide, polyurethane, polyester, silicone, TEFLON, polyacetylene, polypyrrole, polythiophene, polycarbonate, polyvinyl, etc. Fluorine-containing resins are preferably used to increase a contact angle with water.

Specific examples of the fluorine-containing resins include, but are not limited to, polyvinylidenefluoride, polyethylene fluoride, vinylidenefluoride-ethylene tetrafluoride copolymers, vinylidenefluoride-ethylenetetrafluoride-propylenehexafluoride copolymers, etc.

Further, electroconductive materials such as carbon black, graphite, titanium oxide, zinc oxide, tin oxide and iron oxide are optionally included in the surface layer to have a medium resistivity.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The toner of the present invention can be prepared by mixing the first binder resin including a hydrocarbon wax, the second binder resin and the colorant to prepare a mixture; kneading the mixture to prepare a kneaded mixture; cooling the kneaded mixture to prepare a hardened mixture; pulverizing the hardened mixture to prepare a pulverized mixture; classifying the pulverized mixture to prepare a colored particulate resin having a desired particle diameter; and mixing the colored particulate resin with an external additive.

### Examples 1 to 4 and Comparative Examples 1 to 7

### [Preparation of the First Binder Resin]

600 g of styrene, 110 g of butylacrylate, 30 g of acrylic acid as vinyl monomers and 30 g of dicumylperoxide as a polymerization initiator are placed in a dropping funnel to prepare a mixed liquid. 1,230 g of polyoxypropylene (2,2)-2,2-bis(4-hydroxyphenyl)propane, 290 g of polyoxyethylene (2,2)-2,2-bis(4-hydroxyphenyl)propane, 250 g of isododecenylsuccinicanhydride, 310 g of terephthalic acid and 180 g of 1,2,4-benznetricarbonateanhydride as polyol; and 7 g of dibutyltinoxide as an esterification catalyst are mixed to prepare a polyester monomer. 4 parts by weight of paraffin wax having a melting point of 73.3° C. and a half-value width of the endothermic peak of 4° C. when measured with a differential scanning calorimeter and 100 parts by weight of the polyester monomer are placed in a 5-liter four-neck flask having a thermometer, a stainless stirrer, a falling condenser and a nitrogen inlet tube to prepare a mixture. The mixed liquid including the vinyl monomers and polymerization initiator is dropped for 1 hr in a flask under a nitrogen atmosphere in a mantle heater at 160° C. while the mixture therein is stirred. After an addition polymerization is continued for 2 hrs at 160° C., a condensation polymerization is performed at 230° C. The polymerization degree is traced by a softening point measured with a constant-load extrusion capillary rheometer, and the reaction is finished when the resultant resin Hl has a desired softening point of 130° C.

### [Preparation of the Second Binder Resin]

2,210 g of polyoxypropylene(2,2)-2,2-bis(4-hydroxyphenyl)propane, 850 g of terephthalic acid and 120 g of 1,2,4-benznetricarbonateanhydride as polyol; and 0.5 g of dibutyltin oxide as an esterification catalyst are placed in a 5-liter four-neck flask having a thermometer, a stainless stirrer, a falling condenser and a nitrogen inlet tube and subjected to a condensation polymerization under a nitrogen atmosphere in a mantle heater at 230° C. The polymerization degree is traced by a softening point measured with a constant-load extrusion capillary rheometer, and the reaction is finished when the resultant resin L1 has a desired softening point of 115° C.

### [Preparation of Toner Particles]

After a masterbatch containing 100 parts by weight of a binder resin including 80 parts by weight of the first binder resin and 20 parts by weight of the second binder resin and 4 parts by weight of a colorant C.I. Pigment Red 57-1 are fully mixed in a HENSCHEL MIXER to prepare a mixture, the mixture is melted and kneaded in a biaxial extruder PCM-30 from Ikegai Corp. to prepare a kneaded mixture. After the kneaded mixture is extended upon application of pressure with a cooling press roller to have a thickness of 2 mm and cooled with a cooling belt to prepare a hardened mixture, the hardened mixture is crushed with a feather mill to prepare a crushed mixture. Then, the crushed mixture is pulverized with a mechanical pulverizer KTM from Kawasaki Heavy Industries, Ltd. to have a volume-average particle diameter of from 10 to 12 μm and further pulverized with a jet pulverizer IDS from Nippon Pneumatic Mfg. Co., Ltd. to prepare a pulverized mixture. The pulverized mixture is classified with a rotor classifier 100ATP from Hosokawa Micron Group to prepare a colored particulate resin 1. The colored particulate resin 1 has a particle diameter of 8.0 μm and a circularity of 0.917. Typically, toners prepared by the above-mentioned method have circularities of from 0.900 to 0.930.

Silica having parts by weight in Table 1-1 are mixed with 100 parts by weight of the colored particulate resin in a HENSCHEL MIXER having a capacity of 20 L under conditions in Table 1-2 to prepare magenta toner particles of Examples 1 to 4 and Comparative Examples 1 to 7. The angles are deflector angles to the inner wall of the mixer and the parallelism is 0°.

TABLE 1-1

Silica Content

| | 8 nm | 15 nm | 35 nm | 100 nm |
|---|---|---|---|---|
| Example 1 | | 1.2 | 2.7 | |
| Example 2 | | 1.0 | 2.5 | |
| Example 3 | | 0.8 | 2.3 | |
| Example 4 | | 1.0 | 2.5 | |
| Comparative | | 0.9 | 1.3 | |
| Example 1 | | | | |
| Comparative | | 1.3 | 3.0 | |
| Example 2 | | | | |
| Comparative | 1.0 | | 2.3 | |
| Example 3 | | | | |
| Comparative | | 1.0 | | 2.5 |
| Example 4 | | | | |
| Comparative | | 0.8 | 2.3 | |
| Example 5 | | | | |
| Comparative | | 1.4 | 2.1 | |
| Example 6 | | | | |
| Comparative | | 1.5 | 1.0 | |
| Example 7 | | | | |

TABLE 1-2

| | Mixing Conditions | | | | |
|---|---|---|---|---|---|
| | m/s | blade | min | Temp. | Angle |
| Example 1 | 50 | ST | 20 | 25 | 0 |
| Example 2 | 50 | ST | 20 | 25 | 0 |
| Example 3 | 50 | ST | 15 | 35 | 0 |
| Example 4 | 50 | Y | 10 | 25 | 0 |
| Comparative | 50 | ST | 20 | 25 | 0 |
| Example 1 | | | | | |
| Comparative | 50 | ST | 20 | 25 | 0 |
| Example 2 | | | | | |
| Comparative | 50 | ST | 20 | 25 | 0 |
| Example 3 | | | | | |
| Comparative | 50 | ST | 20 | 25 | 0 |
| Example 4 | | | | | |
| Comparative | 50 | Y | 25 | 30 | 90 |
| Example 5 | | | | | |
| Comparative | 50 | Y | 20 | 25 | 45 |
| Example 6 | | | | | |
| Comparative | 50 | ST | 15 | 25 | 0 |
| Example 7 | | | | | |

The volume-average particle diameters, circularities, contents of external additives, adherence strength and total energies of the toners prepared in Examples 1 to 4 and Comparative Examples 1 to 7 are measured, and the resultant image qualities are evaluated. The results are shown in Table 2.

### [Total Energy Measurement with Powder Rheometer]

A powder rheometer FT4 from Freeman Technology is used. A split container having a capacity of 160 ml is attached to a glass container having a capacity of 200 ml, which is included in the powder rheometer, and 85.0 g of the toner are placed in the split container. After 7-times conditioning, a level split container of the toner was set in the glass container having a capacity of 200 ml.

A blade having a diameter of 48 mm, which is included in the powder rheometer, proceeds into the toner at an approach speed of 30 mm/s, and energies applied to the blade and an electronic balance equipped under the glass container are measured while changing the rotation speed of the blade. The total energy (mJ) is a sum of the energies applied thereto. A compression piston for 20 ml, which is included in the powder rheometer, is used for a load of 5N.

The average particle diameter and particle diameter distribution of the toner can be measured by a Coulter counter TA-II or Coulter Multisizer II from Beckman Coulter, Inc. as follows:

0.1 to 5 ml of a detergent, preferably alkylbenzene sulfonate is included as a dispersant in 100 to 150 ml of the electrolyte ISOTON R-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

### [Average Circularity]

The shape of a toner is suitably measured by an optical detection method of passing a suspension liquid including a particle through a plate-shaped imaging detector to detect and analyze an image of the particle. A peripheral length of a circle having an area equivalent to that of a projected image optically detected is divided by an actual peripheral length of the toner particle to determine the circularity of a toner. A toner having an average circularity not less than 0.890, preferably of from 0.900 to 0.930, effectively produces images having appropriate density, reproducibility and high definition. Specifically, the circularity of the toner is measured by a flow-type particle image analyzer FPIA-2000 from SYSMEX CORPORATION. A specific measuring method includes adding 0.1 to 0.5 ml of a surfactant, preferably an alkylbenzenesulfonic acid, as a dispersant in 100 to 150 ml of water from which impure solid materials are previously removed; adding 0.1 to 0.5 g of the toner in the mixture; dispersing the mixture including the toner with an ultrasonic disperser for 1 to 3 min to prepare a dispersion liquid having a concentration of from 3,000 to 10,000 pieces/μl; and measuring the toner shape and distribution with the above-mentioned measurer.

### [Adherence Strength of External Additive]

After 2 g of the toner is put in 30 cc of a surfactant solution including a surfactant of 10% by weight and the surfactant is fully applied to the toner, energy is applied to the toner with an ultrasonic homogenizer at 40 W for 1 min to separate the toner. Then, the toner is washed and dried. The adherent amounts of an inorganic particulate material before and after the toner is subjected to the surfactant are measured with a fluorescence X-ray spectrometer. A wavelength-dispersive fluorescence X-ray spectrometer XRF1700 from Shimadzu Corp. is used to determine an individual element such as silicon of silica by a calibration method from toner pellets prepared by applying a force of 1N/cm² to 2 g of the toner before and after subjected to the surfactant.

The fluidizer preferably has an adherence strength to a mother toner of from 45 to 65%. When less than 45%, free fluidizers adversely affect the resultant image. When greater than 65%, the fluidizers are buried in the mother toner too much, resulting in fading of the spacer effect.

### [Adherence Between Toners]

This can be measured by a compression and tensile characteristics measurer such as AGGROBOT from Hosokawa Micron Group. Specifically, after 7.0 g of the toner is filled in a vertically-dividable cell and a load of 8 kg was applied to the cell for 5 min, a strength required to bring up the upper cell is the adherence between toners. An air conditioning system included in the compression and tensile characteristics measurer was used to control the atmospheric temperature.

The temperature preferably changes less for the adherence between toners. When the adherence between toners is too large, the toner behavior is not stable at a place where the toner receives a stress. The adherence between toners is preferably from 45 to 55 g in an atmosphere of 25° C. The adherence between toners is preferably from 50 to 70 g in an atmosphere of 45° C.

### [Evaluation of Image Quality]

Each of the toners prepared in Examples 1 to 4 and Comparative Examples 1 to 7 is set in a color laser printer Ipsio CX3000 to evaluate the resultant image qualities. The results are shown in Table 2-1, 2-2 and 2-3.

### (Toner Transportability)

Toner blockage occurs when the linear speed is halved: x

Does not occur: ∘

### (Image Density)

Uneven image density due to unstable toner supply: x

No uneven image density: ∘

### (Toner Anchoring on the Blade)

Stripe images on a halftone image after 500 blank images are produced are visually observed.

No stripe image: ∘

Problem: x

### (Killifish Image)

Killifish images on the photoreceptor due to an external additive: x

No killifish image: ∘

TABLE 2-1

| | | | Energy Ratio | | |
|---|---|---|---|---|---|
| | Total Energy | | 10 mm/ | Load | |
| | 100 mm/s | 10 mm/s | 100 mm | 10 mm | 100 mm |
| Example 1 | 454 | 999 | 2.2 | 65.6 | 21.2 |
| Example 2 | 490 | 1230 | 2.5 | 69.7 | 26 |
| Example 3 | 512 | 1434 | 2.8 | 70 | 25.3 |
| Example 4 | 509 | 1476 | 2.9 | 74.9 | 25.6 |
| Comparative | 548 | 1808 | 3.3 | 76.8 | 33.2 |
| Example 1 | | | | | |
| Comparative | 448 | 941 | 2.1 | 77.6 | 28.4 |
| Example 2 | | | | | |
| Comparative | 554 | 1717 | 3.1 | 80.2 | 38.7 |
| Example 3 | | | | | |
| Comparative | 463 | 1065 | 2.3 | 79.5 | 29.5 |
| Example 4 | | | | | |
| Comparative | 623 | 2554 | 4.1 | 89.3 | 41.5 |
| Example 5 | | | | | |
| Comparative | 544 | 1578 | 2.9 | 76.9 | 32.8 |
| Example 6 | | | | | |
| Comparative | 469 | 1500 | 3.2 | 78.3 | 29.9 |
| Example 7 | | | | | |

TABLE 2-2

| | | | | Adherence between | |
|---|---|---|---|---|---|
| | 5 N Energy | | | Toners | |
| | First | Second | Adherence strength | 25° C. | 45° C. |
| Example 1 | 870 | 459 | 48 | 47 | 62 |
| Example 2 | 956 | 487 | 49 | 49 | 65 |
| Example 3 | 919 | 554 | 59 | 54 | 69 |
| Example 4 | 936 | 544 | 57 | 52 | 68 |
| Comparative | 1028 | 551 | 67 | 59 | 73 |
| Example 1 | | | | | |
| Comparative | 611 | 433 | 42 | 42 | 53 |
| Example 2 | | | | | |
| Comparative | 1055 | 552 | 66 | 58 | 71 |
| Example 3 | | | | | |
| Comparative | 778 | 443 | 28 | 36 | 51 |
| Example 4 | | | | | |
| Comparative | 1062 | 579 | 71 | 64 | 81 |
| Example 5 | | | | | |
| Comparative | 1019 | 507 | 68 | 57 | 75 |
| Example 6 | | | | | |
| Comparative | 794 | 449 | 43 | 43 | 56 |
| Example 7 | | | | | |

TABLE 2-3

| | Image Quality | | | |
|---|---|---|---|---|
| | Toner | | | |
| | anchoring | Toner | Image | Killifish |
| | on blade | transportability | density | image |
| Example 1 | ◯ | ◯ | ◯ | ◯ |
| Example 2 | ◯ | ◯ | ◯ | ◯ |
| Example 3 | ◯ | ◯ | ◯ | ◯ |
| Example 4 | ◯ | ◯ | ◯ | ◯ |
| Comparative | X | X | X | ◯ |
| Example 1 | | | | |
| Comparative | ◯ | ◯ | ◯ | X |
| Example 2 | | | | |
| Comparative | X | X | X | ◯ |
| Example 3 | | | | |
| Comparative | X | ◯ | ◯ | X |
| Example 4 | | | | |
| Comparative | ◯ | XX | X | ◯ |
| Example 5 | | | | |
| Comparative | X | X | X | ◯ |
| Example 6 | | | | |
| Comparative | ◯ | ◯ | ◯ | X |
| Example 7 | | | | |

This application claims priority and contains subject matter related to Japanese Patent Application No. 2006-104438 filed on Apr. 5, 2006, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An oilless-fixing toner for use in a vertical image developer comprising a toner feeder configured to feed the oilless-fixing toner vertically below; a developing roller configured to be located vertically below the toner feeder; and a screw blade configured to agitate the oilless-fixing toner; wherein the oilless-fixing toner comprises:
a resin comprising a wax;
a colorant; and
an external additive,
wherein a total energy determined from a torque and a load of the screw blade is from 450 to 530 mJ when rotating in the oilless-fixing toner at 100 mm/s, and a ratio of total energy at 10 mm/s to total energy at 100 mm/s is from 2.0 to 3.0.

2. The oilless-fixing toner of claim 1, wherein the toner feeder is a toner feed roller contacting and facing the developing roller.

3. The oilless-fixing toner of claim 1, wherein the oilless-fixing toner is fed to the developing roller due to gravity.

4. The oilless-fixing toner of claim 1, wherein the screw blade has a load of from 20 to 30 mJ when rotating in the oilless-fixing toner at 100 mm/s, and from 65 to 75 mJ when rotating in the oilless-fixing toner at 10 mm/s.

5. The oilless-fixing toner of claim 1, wherein the oilless-fixing toner has an average circularity of from 0.900 to 0.930.

6. The oilless-fixing toner of claim 1, wherein the external additive is a fluidizer included in an amount of 2.5 to 4.0 parts by weight per 100 parts by weight of the resin comprising a wax and the colorant.

7. The oilless-fixing toner of claim 6, wherein the fluidizer has an average primary particle diameter of from 10 to 50 nm.

8. The oilless-fixing toner of claim 6, wherein the fluidizer is silica having an adherence strength of from 45 to 65% to the resin comprising a wax and the colorant.

9. The oilless-fixing toner of claim 1, wherein the oilless-fixing toner has an adherence therebetween of from 45 to 55 g at 250C, and from 50 to 70 g at 45° C.

10. The oilless-fixing toner of claim 1, wherein the total energy determined from a torque and a load of the screw blade is from 800 to 1,000 mJ when rotating in the oilless-fixing toner after a load of 5N is applied thereto.

11. The oilless-fixing toner of claim 1, wherein the total energy continuously determined from a torque and a load of the screw blade is from 450 to 550 mJ when rotating in the oilless-fixing toner for the second time after a load of 5N is applied thereto.

12. The oilless-fixing toner of claim 1, wherein the oilless-fixing toner comprises the wax in an amount of from 3 to 10 parts by weight per 100 parts by weight of the oilless-fixing toner.

13. An image forming apparatus, comprising an image developer comprising:
a toner container configured to contain the oilless-fixing toner according to claim 1;
a toner feed chamber configured to be located under the toner container;
a developing roller configured to be located below the toner feed chamber;
a layer regulator configured to regulate a layer of the oilless-fixing toner on the developing roller while contacting thereto; and
a feed roller configured to feed the oilless-fixing toner to the developing roller while contacting thereto.

14. The image forming apparatus of claim 13, further comprising a fixer, wherein the fixer is a two-roll fixer comprising a heat roller and a pressure roller.

15. The image forming apparatus of claim 14, wherein the fixer is an oilless fixer without application of an oil to a fixing member thereof.

16. An image forming method, comprising:
charging a photoreceptor to form an electrostatic latent image thereon;
developing the electrostatic latent image with the oilless-fixing toner according to claim 1 to form a toner image on the photoreceptor;
transferring the toner image onto a transfer sheet;
fixing the toner image on the transfer sheet; and
cleaning the photoreceptor to remove the toner remaining thereon.

17. An image forming apparatus, comprising:
a photoreceptor;
a charger configured to charge the photoreceptor to form an electrostatic latent image thereon;
an image developer configured to develop the electrostatic latent image with the oilless-fixing toner according to claim 1 to form a toner image on the photoreceptor;
a transferer configured to transfer the toner image onto a transfer sheet;
a fixer configured to fix the toner image on the transfer sheet; and
a cleaner configured to clean the photoreceptor to remove the toner remaining thereon.

18. The image forming apparatus of claim 17, wherein the image forming apparatus is a printer, a duplicator or a facsimile.

19. A process cartridge, comprising:
a photoreceptor;
an image developer configured to develop an electrostatic latent image on the photoreceptor with the oilless-fixing toner according to claim 1; and
at least one of a charger and a cleaner.
